(19) United States
(12) Patent Application Publication
(10) Pub. No.: US 2017/0058438 A1
(43) Pub. Date: Mar. 2, 2017

(54) Three-Dimensional Woven Composite Vehicle Components for Crashworthiness

(71) Applicant: Albany Engineered Composites, Inc., Rochester, NH (US)

(72) Inventors: Harun H. Bayraktar, Newfields, NH (US); Michael Brent Stevenson, Milton, NH (US)

(21) Appl. No.: 15/254,595

(22) Filed: Sep. 1, 2016

Related U.S. Application Data
(60) Provisional application No. 62/213,419, filed on Sep. 2, 2015.

(51) Int. Cl. D03D 25/00; D03D 11/00; B29C 70/24; D03D 3/00

(52) U.S. Cl. CPC D03D 25/005; D03D 3/00; D03D 11/00; B29C 70/24; B29K 2063/00

(57) ABSTRACT

Described is a three-dimensional (3D) woven composites with high specific energy absorption (SEA) that significantly outperforms traditional two dimensional (2D) woven laminated composites of substantially the same weight.

### BACKGROUND

1. Field of Invention

This application relates to three-dimensional (3D) woven composites with high specific energy absorption (SEA) that significantly outperform traditional 2D laminated composites enabling the manufacturing of 3D woven composite parts that can replace ones made from traditional materials such as laminated composites or high strength metals, at a lighter weight.

2. Description of Related Art

Due the presence of through-thickness reinforcement, 3D woven composites have superior fracture toughness, fatigue life, and damage tolerance compared to laminated composites. Furthermore, 3D woven composites exhibit a progressive damage behavior that is more benign than the typical catastrophic failure behavior of laminated composites. These properties lead to high specific energy absorption (SEA)—an industry accepted common measure of energy absorbed by destructed weight of a specimen or part—enabling the manufacturing of 3D woven composite parts that can replace ones made from traditional materials such as laminated composites or high strength metals, at a lighter weight.

### SUMMARY OF THE DISCLOSURE

The present disclosure provides 3D woven preforms that can be impregnated with a matrix material to form composites that significantly outperform traditional 2D laminated composites. The presently disclosed technology can be used to make parasitic or load-bearing structural components for improved crashworthiness of vehicles (land, water, or air). “Parasitic” is a term commonly used in composites. “Parasitic” in this context means a component used only for the purpose of energy absorption. Applications of the presently disclosed technology can range from sacrificial crash tubes to multi-purpose structural components.

In the disclosed 3D ply-to-ply woven preforms, each warp fiber ties the weft layer below or above it. As such, the 3D woven composite—a preform impregnated with a matrix material—can provide through thickness reinforcement that does not exist in laminated composites and also can reduce delamination as a mode of composite failure because no plane exists within the composite that a reinforcement yarn (warp or weft) does not cross. The lack of such planes act to stop the propagation of cracks through the structure hence increasing the amount of force and energy required to crush the 3D composite.

In one embodiment a three-dimensional (3D) composite article includes a 3D woven preform. The preform has a plurality of warp yarns and a plurality of weft yarns. The warp yarns are woven with the weft yarns to form a structure having a plurality of layers of the 3D woven preform. The 3D woven composite article has a specific energy absorption (SEA) greater than a 2D woven laminated preform of substantially the same weight, when each preform is impregnated with a matrix material to form the composite article.

In some implementations the 3D woven composite article has the specific energy absorption (SEA) at least 10% greater than a 2D woven laminated preform of substantially the same weight. In other implementations the 3D composite article has the specific energy absorption (SEA) at least 20% greater than a 2D woven laminated preform of substantially the same weight.

Also disclosed is a three-dimensional (3D) woven preform. The preform has a plurality of warp yarns and a plurality of welt yarns. The warp yarns are woven with the weft yarns to form a structure having a plurality of layers of the 3D woven preform. The one or more warp yarns selected from the plurality of warp yarns in a particular layer are first binder yarns that bind weft yarns in the particular layer to weft yarns in a another layer, and the one or more weft yarns selected from the plurality of weft yarns in the particular layer are second binder yarns that bind warp yarns in the particular layer to warp yarns in the another layer.

Also, disclosed is a method of forming a three-dimensional (3D) woven composite article by forming a 3D woven preform. The preform is formed by weaving a plurality of warp yarns with a plurality of weft yarns to form a structure having a plurality of layers of the 3D woven preform. The 3D woven composite has a specific energy absorption (SEA) greater than a 2D woven laminated preform of substantially the same weight, when each preform is impregnated with a matrix material to form the composite article.

The method of forming a three-dimensional (3D) woven composite article can also include binding weft yarns in a particular layer to weft yarns in another layer with first binder yarns, the first binder yarns being one or more warp yarns selected from the plurality of warp yarns in the particular layer, and also binding warp yarns in a particular layer to warp yarns in the another layer with second binder yarns, the second binder yarns being one or more weft yarns selected from the plurality of weft yarns in the particular layer.

In some implementations the preform has the specific energy absorption (SEA) at least 10% greater than the 2D woven laminated preform of substantially the same weight. In other implementations the preform has the specific energy absorption (SEA) at least 20% greater than the 2D woven laminated preform of substantially the same weight.

Further, a method of forming a three-dimensional (3D) woven preform includes weaving a plurality of warp yarns with a plurality of weft yarns to form a structure having a plurality of layers of the 3D woven preform. One or more warp yarns selected from the plurality of warp yarns in a particular layer are first binder yarns that bind weft yarns in the particular layer to weft yarns in a another layer, and one or more weft yarns selected from the plurality of weft yarns in the particular layer are second binder yarns that bind warp yarns in the particular layer to warp yarns in the another layer.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like.

The above and other objects, features, and advantages of various embodiments as set forth in the present disclosure will be more apparent from the following detailed description of embodiments taken in conjunction with the accompanying drawings.

### BRIEF DESCRIPTION OF THE DRAWINGS

FIG. 1A illustrates an example of 3D woven preform ply-to-ply architecture 3D-P1-50 of the present disclosure.

FIG. 1B illustrates a cross sectional plane A along the warp threads of the 3D woven preform architecture 3D-P1-50 shown in FIG. 1A.

FIG. 1C illustrates a cross sectional plane B along the warp threads of the 3D woven preform architecture 3D-P1-50 shown in FIG. 1A.

FIG. 1D illustrates a cross sectional plane C along the warp threads of the 3D woven preform architecture 3D-P1-50 shown in FIG. 1A.

FIG. 1E illustrates a cross sectional plane D along the warp threads of the 3D woven preform architecture 3D-P1-50 shown in FIG. 1A.

FIG. 1F illustrates a cross sectional plane E along the weft threads of the 3D woven preform architecture 3D-P1-50 shown in FIG. 1A.

FIG. 1G illustrates a cross sectional plane F along the weft threads of the 3D woven preform architecture 3D-P1-50 shown in FIG. 1A.

FIG. 1H illustrates a cross sectional plane G along the weft threads of the 3D woven preform architecture 3D-P1-50 shown in FIG. 1A.

FIG. 1I illustrates a cross sectional plane H along the weft threads of the 3D woven preform architecture 3D-P1-50 shown in FIG. 1A.

FIG. 2 illustrates a single warp column of the 3D woven preform architecture 3D-P1-70.

FIG. 3 illustrates a single warp column of the 3D woven preform architecture 3D-P2-50.

FIG. 4 illustrates a single warp column of the 3D woven preform architecture 3D-O50.

FIG. 5 illustrates a single warp column of the 3D woven preform architecture 3D-O70.

FIG. 6 illustrates corrugated composite test specimen before, during, and after testing.

FIG. 7 illustrates a quasi-static SEA comparison of all eight configurations tested with 3D woven composites and 2D laminated composites.

FIG. 8 illustrates a chart comparing rate dependent SEA values for four configurations.

FIG. 9 illustrates four variants of a possible automotive application for the development of a 3D woven composite longitudinal component.

### DETAILED DESCRIPTION

The terms “threads”, “fibers”, and “yarns” are used interchangeably in the following description. “Threads”, “fibers”, and “yarns” as used herein can refer to monofilaments, multifilament yarns, twisted yarns, multifilament tows, textured yarns, braided tows, coated yarns, bicomponent monofilament yarns, as well as yarns made from stretch broken fibers or any other such materials.

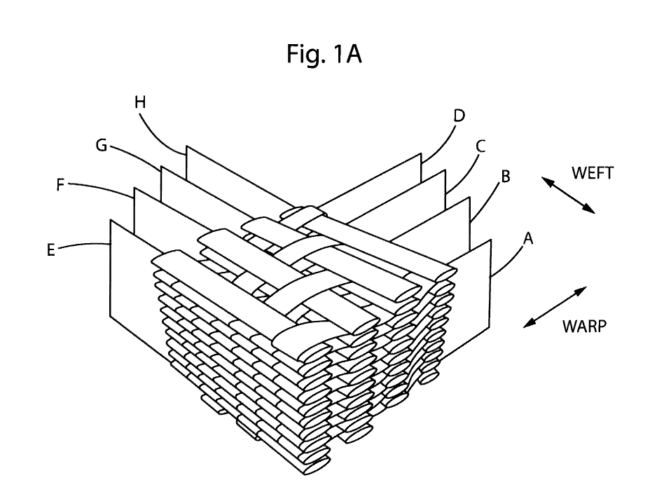

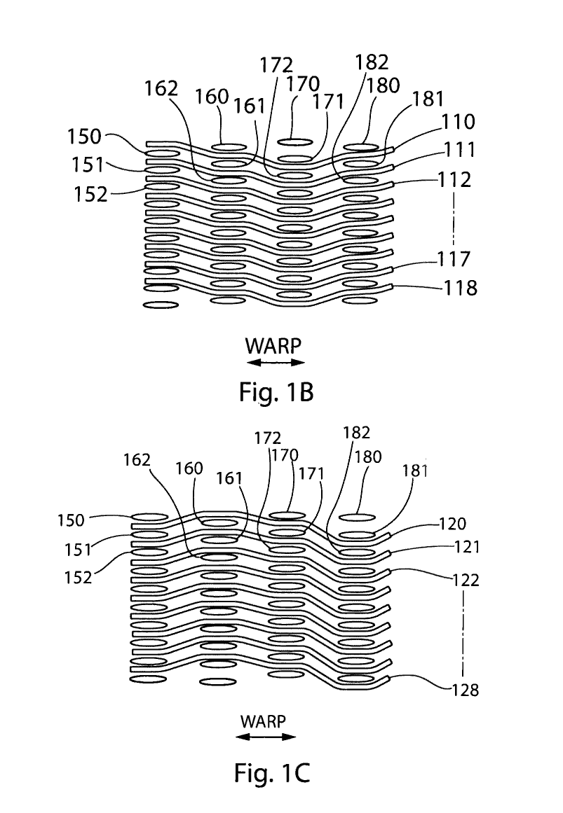

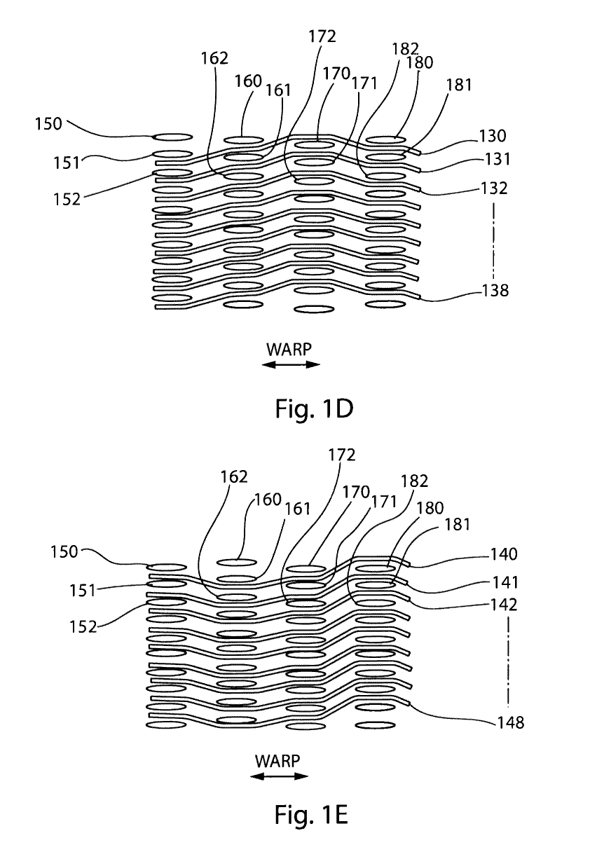

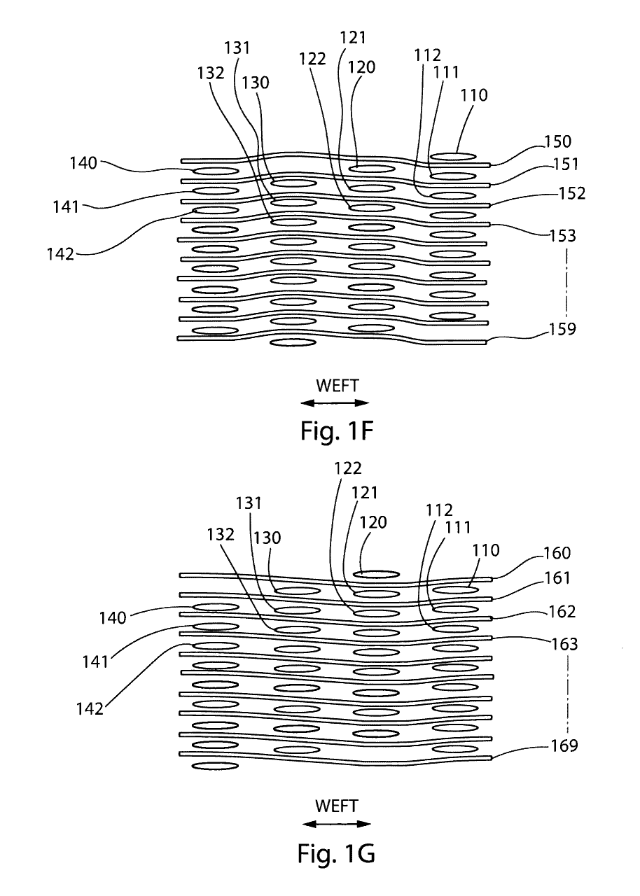

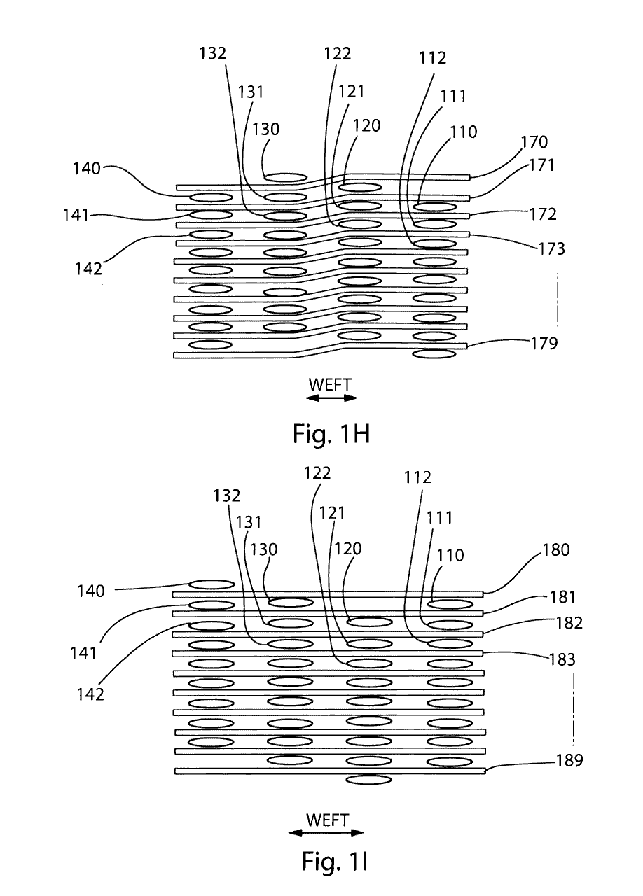

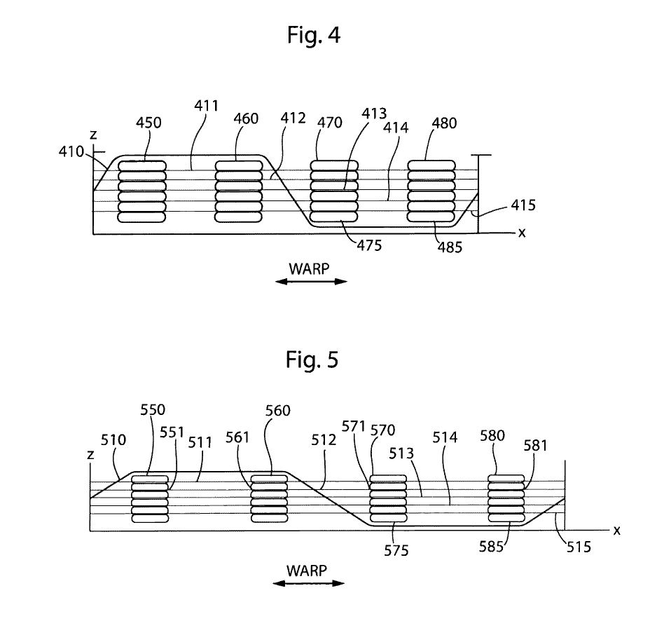

FIGS. 1A and 2-5 illustrate five examples of cross sectional planes of 3D woven structures, which differ in the amount of through-thickness reinforcement and the balance of the number of fibers in the warp and weft direction (also known as warp/weft ratio). Each layer in the structure is formed by weaving warp and weft fibers. The warp/weft ratio here indicates the warp percentage by volume of the total fiber. The warp/weft ratio may be used to quantify the percentage of yarns in the warp and weft directions, and tailored for performance reasons (i.e., stiffness and strength). The 3D woven preforms in FIGS. 1A, 2, and 3, which are 3D-P1-50, 3D-P1-70, and 3D-P2-50, respectively, are three variations of ply-to-ply architectures denoted by 3D-P. The 3D woven preforms in FIGS. 4 and 5, which are 3D-O50 and 3D-O70, respectively, are two variations of orthogonal weaves with higher through-thickness reinforcement. The 50 or 70 refer to the warp/weft ratio, i.e., the warp percentage by volume of the total fiber.

FIG. 1A illustrates an example of 3D woven preform ply-to-ply architecture 3D-P1-50 of the present disclosure. The 3D woven perform 3D-P1-50 is a ply-to-ply standard crimp 3D weave with 50/50% warp/weft ratio. FIG. 1B illustrates a cross sectional plane A along the warp threads of the 3D woven preform architecture 3D-P1-50 shown in FIG. 1A. The cross sectional plane A includes warp threads 110, 111, 112, 113 . . . 117, and 118. As shown in FIG. 1B, during the weaving of the 3D woven preform, first warp thread 110 in the first layer is woven over the weft thread 150 in the first layer, then under the weft thread 160, then under the weft thread 171, and finally under the weft thread 180. Therefore, the first weft row that includes weft threads 150, 160, 170, and 180, and the second weft row that includes weft threads 151, 161, 171, and 181, are tied to each other in the cross sectional plane A. In a similar manner, in the next weft row, the second warp thread 111 in the second layer is woven over the weft thread 151 in the second layer, then under the weft thread 161, then under the weft thread 172, and finally under the weft thread 181. Therefore, the second weft row that includes weft threads 151, 161, 171, and 181, and the third weft row that includes weft threads 152, 162, 172, and 182, are tied to each other in the cross sectional plane A. The other warp threads in the cross sectional plane A, i.e., 112, 113 . . . 117, and 118 are all woven in the pattern similar to warp threads 110 and 111. Therefore, each weft row and a subsequent weft row are tied to each other in the cross sectional plane A. FIG. 1C illustrates a cross sectional plane B along the warp threads of the 3D woven preform architecture 3D-P1-50 shown in FIG. 1A. The cross sectional plane B includes warp threads 120, 121, 122 . . . 128. As shown in FIG. 1C, during the weaving of the 3D woven preform, the warp thread 120 in the first layer is woven under the weft thread 150, then over the weft thread 160 in the first layer, then under the weft thread 170, and finally under the weft thread 181. Therefore, the first weft row that includes weft threads 150, 160, 170, and 180, and the second weft row that includes weft threads 151, 161, 171, and 181, are tied to each other in the cross sectional plane B. In a similar manner, in the next weft row, the warp thread 121 is woven under the weft thread 151, then over the weft thread 161, then under the weft thread 171, and finally under the weft thread 182. Therefore, the second weft row that includes weft threads 151, 161, 171, and 181, and the third weft row that includes weft threads 152, 162, 172, and 182, are tied to each other in the cross sectional plane B. The other warp threads in the cross sectional plane A, i.e., 122, 123 . . . 128 are all woven in the pattern similar to warp threads 120 and 121. Therefore, each weft row and a subsequent weft row are tied to each other in the cross sectional plane B.

FIG. 1D illustrates a cross sectional plane C along the warp threads of the 3D woven preform architecture 3D-P1-50 shown in FIG. 1A. The cross sectional plane C includes warp threads 130, 131, 132 . . . 138. As shown in FIG. 1D, during the weaving of the 3D woven preform, the warp thread 130 in the first layer is woven under the weft thread 151 in the second layer, then under the weft thread 160, then over the weft thread 170, and finally under the weft thread 180. Therefore, the first weft row that includes weft threads 150, 160, 170, and 180, and the second weft row that includes weft threads 151, 161, 171, and 181, are tied to each other in the cross sectional plane C. In a similar manner, in the next weft row, the warp thread 131 is woven under the weft thread 152, then under the weft thread 161, then over the weft thread 171, and finally under the weft thread 181. Therefore, the second weft row that includes weft threads 151, 161, 171, and 181, and the third weft row that includes weft threads 152, 162, 172, and 182, are tied to each other in the cross sectional plane C. The other warp threads in the cross sectional plane A, i.e., 132 . . . 138 are all woven in the pattern similar to warp threads 130 and 131. Therefore, each weft row and a subsequent weft row are tied to each other in the cross sectional plane C.

FIG. 1E illustrates a cross sectional plane D along the warp threads of the 3D woven preform architecture 3D-P1-50 shown in FIG. 1A. The cross sectional plane D includes warp threads 140, 141, 142 . . . 148. As shown in FIG. 1E, during the weaving of the 3D woven preform, the warp thread 140 in the first layer is woven under the weft thread 150 in the first layer, then under the weft thread 161, then under the weft thread 170, and finally over the weft thread 180. Therefore, the first weft row that includes weft threads 150, 160, 170, and 180, and the second weft row that includes weft threads 151, 161, 171, and 181, are tied to each other in the cross sectional plane D. In a similar manner, in the next weft row, the warp thread 141 is woven under the weft thread 151, then under the weft thread 162, then under the weft thread 171, and finally over the weft thread 181. Therefore, the second weft row that includes weft threads 151, 161, 171, and 181, and the third weft row that includes weft threads 152, 162, 172, and 182, are tied to each other in the cross sectional plane D. The other warp threads in the cross sectional plane A, i.e., 142 . . . 148 are all woven in the pattern similar to warp threads 140 and 141. Therefore, each welt row and a subsequent weft row are tied to each other in the cross sectional plane D. In these examples 1B-1E weft fibers of a particular layer or row are tied to weft fibers of the “subsequent weft layer”, which is the adjacent next layer to the particular warp layer being described. However, the term “subsequent weft layer” is used only for ease of description of the figures and is meant to be interpreted more broadly. In particular, as used herein “subsequent weft layer” means “another weft layer.” And such subsequent weft row or layer can be the adjacent next weft row or layer or multiple weft rows or layers distant, above or below, from the particular warp row or layer being described.

FIG. 1F illustrates a cross sectional plane E along the weft threads of the 3D woven preform architecture 3D-P1-50 shown in FIG. 1A. The cross sectional plane E includes weft threads 150, 151, 152 . . . 159. As shown in FIG. 1F, during the weaving of the 3D woven preform, the weft thread 151 in the second layer is woven over the warp thread 141 in the second layer, then over the warp thread 130, then over the warp thread 121, and finally under the warp thread 111. Therefore, the first warp row that includes warp threads 140, 130, 120, and 110, and the second warp row that includes warp threads 141, 131, 121, and 111, are tied to each other in the cross sectional plane E. In a similar manner, in the next warp row, the weft thread 152 is woven over the warp thread 142, then over the warp thread 131, then over the warp thread 122, and finally under the warp thread 112. Therefore, the second warp row that includes warp threads 141, 131, 121, and 111, and the third warp row that includes warp threads 142, 132, 122, and 112, are tied to each other in the cross sectional plane E. The other weft threads in the cross sectional plane A, i.e., 153 . . . 159 are all woven in the pattern similar to weft threads 150 and 151. Therefore, each warp row and a subsequent warp row are tied to each other in the cross sectional plane E. FIG. 10 illustrates a cross sectional plane F along the weft threads of the 3D woven preform architecture 3D-P1-50 shown in FIG. 1A. The cross sectional plane F includes weft threads 160, 161, 162 . . . 169. As shown in FIG. 1G, during the weaving of the 3D woven preform, the weft thread 161 in the second layer is woven over the warp thread 140 in the first layer, then over the warp thread 131, then under the warp thread 121, and finally over the warp thread 111. Therefore, the first warp row that includes warp threads 140, 130, 120, and 110, and the second warp row that includes warp threads 141, 131, 121, and 111, are tied to each other in the cross sectional plane F. In a similar manner, in the next warp row, the weft thread 162 is woven over the warp thread 141, then over the warp thread 132, then under the warp thread 122, and finally over the warp thread 112. Therefore, the second warp row that includes warp threads 141, 131, 121, and 111, and the third warp row that includes warp threads 142, 132, 122, and 112, are tied to each other in the cross sectional plane F. The other weft threads in the cross sectional plane A, i.e., 163 . . . 169 are all woven in the pattern similar to weft threads 160 and 161. Therefore, each warp row and a subsequent warp row are tied to each other in the cross sectional plane F.

FIG. 1H illustrates a cross sectional plane G along the weft threads of the 3D woven preform architecture 3D-P1-50 shown in FIG. 1A. The cross sectional plane G includes weft threads 170, 171, 172 . . . 179. As shown in FIG. 1H, during the weaving of the 3D woven preform, the weft thread 171 in the second layer is woven over the warp thread 141 in the second layer, then under the warp thread 131, then over the warp thread 121, and finally over the warp thread 110. Therefore, the first warp row that includes warp threads 140, 130, 120, and 110, and the second warp row that includes warp threads 141, 131, 121, and 111, are tied to each other in the cross sectional plane G. In a similar manner, in the next warp row, the weft thread 172 is woven over the warp thread 142, then under the warp thread 132, then over the warp thread 122, and finally over the warp thread 111. Therefore, the second warp row that includes warp threads 141, 131, 121, and 111, and the third warp row that includes warp threads 142, 132, 122, and 112, are tied to each other in the cross sectional plane F. The other weft threads in the cross sectional plane A, i.e., 173 . . . 179 are all woven in the pattern similar to weft threads 170 and 171. Therefore, each warp row and a subsequent warp row are tied to each other in the cross sectional plane G.

FIG. 1I illustrates a cross sectional plane H along the weft threads of the 3D woven preform architecture 3D-P1-50 shown in FIG. 1A. The cross sectional plane H includes weft threads 180, 181, 182 . . . 189. As shown in FIG. 1I, during the weaving of the 3D woven preform, the weft thread 181 in the second layer is woven under the warp thread 141 in the second layer, then over the warp thread 131, then over the warp thread 120, and finally over the warp thread 111. Therefore, the first warp row that includes warp threads 140, 130, 120, and 110, and the second warp row that includes warp threads 141, 131, 121, and 111, are tied to each other in the cross sectional plane G. In a similar manner, in the next warp row, the weft thread 182 is woven under the warp thread 142, then over the warp thread 132, then over the warp thread 121, and finally over the warp thread 112. Therefore, the second warp row that includes warp threads 141, 131, 121, and 111, and the third warp row that includes warp threads 142, 132, 122, and 112, are tied to each other in the cross sectional plane F. The other weft threads in the cross sectional plane A, i.e., 183 . . . 189 are all woven in the pattern similar to weft threads 180 and 181. Therefore, each warp row and a subsequent warp row are tied to each other in the cross sectional plane H.

In these examples 1F-1I warp fibers of a particular layer or row are tied to warp fibers of the “subsequent warp layer”, which is the adjacent next layer to the particular weft layer being described. However, the term “subsequent warp layer” is used only for ease of description of the figures and is meant to be interpreted more broadly. In particular, as used herein “subsequent warp layer” means “another warp layer.” And such a subsequent warp row or layer can be the adjacent next warp row or layer or multiple warp rows or layers distant, above or below, from the particular weft row or layer being described.

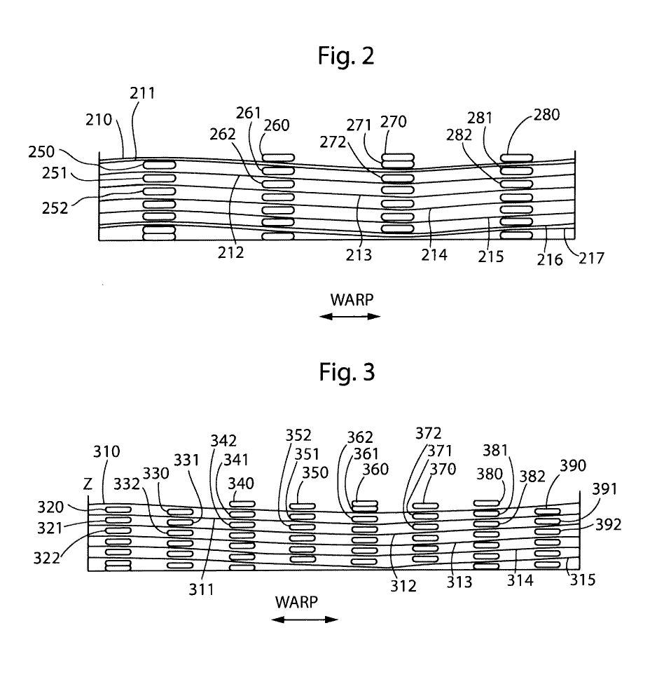

FIG. 2 illustrates a single warp column, i.e., a single cross sectional plane along the warp threads of the 3D woven preform architecture 3D-P1-70. The 3D woven perform 3D-P1-70 is a ply-to-ply standard crimp 3D weave with 70/30% warp/weft ratio. Compared with the 3D-P1-50 shown in FIG. 1A, in the 3D-P1-70 preform, there are two warp threads 210 and 211 in the first layer, and two warp threads 215 and 216 in the last layer, and the distance between weft yarn columns is greater than the distance in the 3D-P1-50 preform. These combined differences achieve a 70% warp percentage while maintaining the same target total fiber volume fraction in the 3D-P-50 preform.

Similar to the 3D woven preform architecture 3D-P1-50 shown in FIG. 1A, in the 3D woven preform architecture 3D-P1-70 there are more cross sectional planes (not shown) that are only different by a shift in the pattern by a weft column.

As shown in FIG. 2, the cross sectional plane includes warp threads 210, 211, 212 . . . 218. As shown in FIG. 2, during the weaving of the 3D woven preform, the warp threads 210 and 211 are woven over the weft thread 250, then under the weft thread 260, then under the weft thread 271, and finally under the weft thread 280. Therefore, the first weft row that includes weft threads 250, 260, 270, and 280, and the second weft row that includes weft threads 251, 261, 271, and 281, are tied to each other in the cross sectional plane. In a similar manner, in the next weft row, the warp thread 212 is woven over the weft thread 251, then under the weft thread 261, then under the weft thread 272, and finally under the weft thread 281. Therefore, the second weft row that includes weft threads 251, 261, 271, and 281, and the third weft row that includes weft threads 252, 262, 272, and 282, are tied to each other in the cross sectional plane. The warp threads 213, 214, and 215 are woven in the pattern similar to warp thread 212, and the warp threads 216 and 217 are woven in the pattern similar to warp thread 210 and 211. Therefore, each weft row and a subsequent weft row are tied to each other in the cross sectional plane.

FIG. 3 illustrates a single warp column, i.e., a single cross sectional plane along the warp threads of the 3D woven preform architecture 3D-P2-50. The 3D woven perform 3D-P2-50 is a ply-to-ply low crimp 3D weave with 50/50% warp/weft ratio. In the 3D-P2-50 preform, lower crimp is achieved through alternating weft yarn counts in each weft column. Similar to the 3D woven preform architecture 3D-P1-50 shown in FIG. 1A, in the 3D woven preform architecture 3D-P2-50 there are more cross sectional planes (not shown) that are only different by a shift in the pattern by a weft column.

As shown in FIG. 3, the cross sectional plane includes warp threads 310, 311 . . . 314, and 315. As shown in FIG. 3, during the weaving of the 3D woven preform, the warp thread 310 is woven over the weft thread 320, then over the weft thread 330, then under the weft thread 340, then under the weft thread 350, then under the weft thread 361, then under the weft thread 370, then under the weft thread 380, and finally over the weft thread 390. Therefore, the first weft row that includes weft threads 320, 330 . . . 380, and 390, and the second weft row that includes weft threads 321, 331 . . . 381, and 391, are tied to each other in the cross sectional plane. In a similar manner, in the next weft row, the warp thread 311 is woven over the weft thread 321, then over the weft thread 331, then under the weft thread 341, then under the weft thread 351, then under the weft thread 362, then under the weft thread 371, then under the weft thread 381, and finally over the weft thread 391. Therefore, the second weft row that includes weft threads 321, 331 . . . 381, and 391, and the third weft row that includes weft threads 322, 332 . . . 392, are tied to each other in the cross sectional plane. Other warp threads 312, 313, 314, and 315 are woven in the pattern similar to warp threads 310 and 311. Therefore, each weft row and a subsequent weft row are tied to each other in the cross sectional plane.

FIG. 4 illustrates a single warp column, i.e., a single cross sectional plane along the warp threads of the 3D woven preform architecture 3D-O50. The 3D woven perform 3D-O50 is an orthogonal 3D weave with 50/50% warp/weft ratio. The 3D-O50 preform has very low crimp stuffer yarns (weft) and through-thickness weft binder yarns. This weave in this industry is sometimes referred to as a 3D non-crimp fabric due to the relatively straight stuffer yarns and weft yarns, especially when a smaller through-thickness binder yarn is used. Similar to the 3D woven preform architecture 3D-P1-50 shown in FIG. 1A, in the 3D woven preform architecture 3D-O50 there are more cross sectional planes (not shown) that are only different by a shift in the pattern by a weft column.

As shown in FIG. 4, the cross sectional plane includes warp threads 410, 411 . . . 414, and 415. As shown in FIG. 4, during the weaving of the 3D woven preform, the warp thread 410 is woven over the weft thread 450, then over the weft thread 460, then under the weft thread 475, and finally under the weft thread 485. The warp thread 411 is woven under the weft threads 450, 460, 470, and 480. The other warp threads 412, 413, 414, and 415 are woven in the pattern similar to warp thread 411. Therefore, all six weft rows in the cross sectional plane are tied to each other.

FIG. 5 illustrates a single warp column, i.e., a single cross sectional plane along the warp threads of the 3D woven preform architecture 3D-O70. The 3D woven perform 3D-O70 is an orthogonal 3D weave with 70/30% warp/weft ratio. The 3D-O70 preform has very low crimp weft stuffer yarns and through-thickness binder yarns. Similar to the 3D woven preform architecture 3D-P1-50 shown in FIG. 1A, in the 3D woven preform architecture 3D-O70 there are more cross sectional planes (not shown) that are only different by a shift in the pattern by a weft column.

As shown in FIG. 5, the cross sectional plane includes warp threads 510, 511 . . . 516, and 517. As shown in FIG. 5, during the weaving of the 3D woven preform, the warp thread 510 is woven over the weft thread 550, then over the weft thread 560, then under the weft thread 575, and finally under the weft thread 585. The warp threads 511 and 512 are woven under the weft threads 550, 560, 570, and 580. The warp thread 513 is woven under the weft threads 551, 561, 571, and 581. The warp threads 514 and 515 are woven in the pattern similar to warp thread 513, and the warp threads 516 and 517 are woven in the pattern similar to warp threads 511 and 512. Therefore, all six weft rows in the cross sectional plane are tied to each other.

After the desired 3D woven preform structure has been formed, the structure may be impregnated with a matrix material to form a composite. The structure becomes encased in the matrix material and matrix material fills the interstitial areas between the constituent elements of the structure. The matrix material may be any of a wide variety of materials, such as epoxy, polyester, vinyl-ester, ceramic, carbon and/or other materials, which also exhibit desired physical, thermal, chemical, and/or other properties. The materials chosen for use as the matrix may or may not be the same as that of the structure and may or may not have comparable physical, chemical, thermal or other properties. Typically, however, they will not be of the same materials or have comparable physical, chemical thermal or other properties, because a common objective sought in using composites is to achieve a combination of characteristics in the finished product that is not attainable through the use of one constituent material alone. So combined, the structure and the matrix material may then be cured and stabilized in the same operation by thermosetting or other known methods, and then subjected to other operations toward producing the desired component. After being so cured, the then solidified masses of the matrix material are adhered to the structure. As a result, stress on the finished component, particularly via its matrix material acting as an adhesive between fibers, may be effectively transferred to and borne by the constituent material of the structure.

### Comparative Test Results of Specific Energy Absorption (SEA) of Present Structure

The 3D woven preforms 3D-P1-50, 3D-P1-70, 3D-P2-50, 3D-O50, and 3D-O70 have improved properties that can lead to high specific energy absorption (SEA) that enables the manufacturing of 3D woven composite parts that can replace ones made from traditional materials such as laminated composites or high strength metals, at a lighter weight. In order to demonstrate this, an experimental study was conducted, where the SEA of various 2D laminated and 3D woven carbon-epoxy composites were measured and compared. Three different layups were considered for the 2D laminated composites with the aim of triggering three different energy absorption modes. For 3D woven composites, variations of two primary architectures were considered for a total of five different configurations.

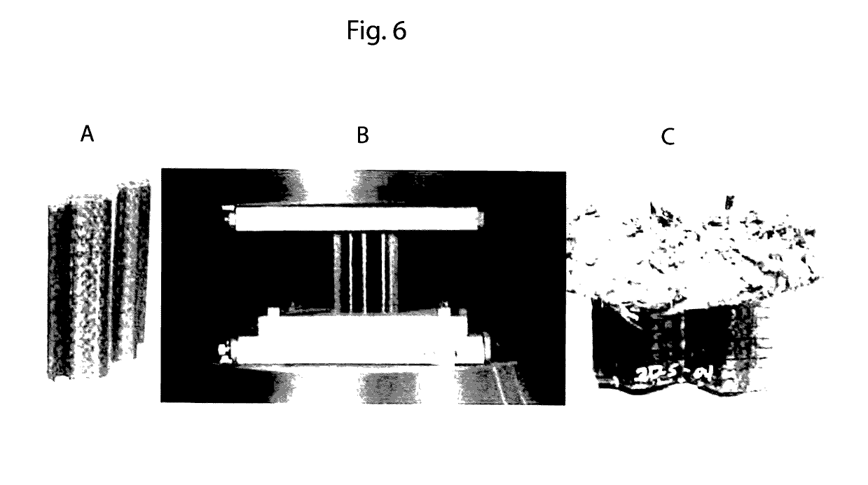

FIG. 6 illustrates a corrugated shaped composite test specimen before (A), during (B), and after (C) testing. Since SEA is a combined material and structural property, test specimens with a corrugated geometry were selected based on published work. All specimens were crushed between flat platens under quasi-static and dynamic conditions, as shown in FIG. 6. The same commercial grade standard modulus carbon fiber and automotive grade epoxy resin was used to manufacture all 2D and 3D composite specimens. Fiber volume fraction for all eight configurations was roughly 60% within manufacturing tolerances. Force-displacement curves measured during testing and specimen weights were used to calculate SEA values.

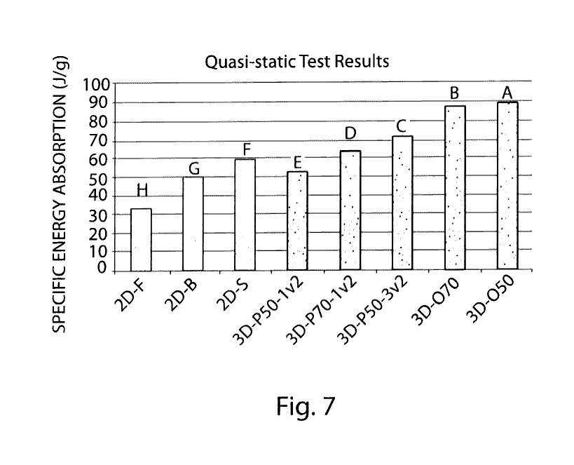

FIG. 7 illustrates a quasi-static SEA comparison of all eight configurations tested with 3D woven composites shown as A-E and 2D laminated composites as F-H. The results of the quasi-static testing showed that all but one 3D woven composite design performed better than all 2D laminated composites. The improvement over 2D-S for one 3D architecture family was 20% for 3D-P50-3v2 and 50% for 3D-O50. Under dynamic loading which better represents an actual crash situation in a vehicle, 3D woven composites performed better than 2D.

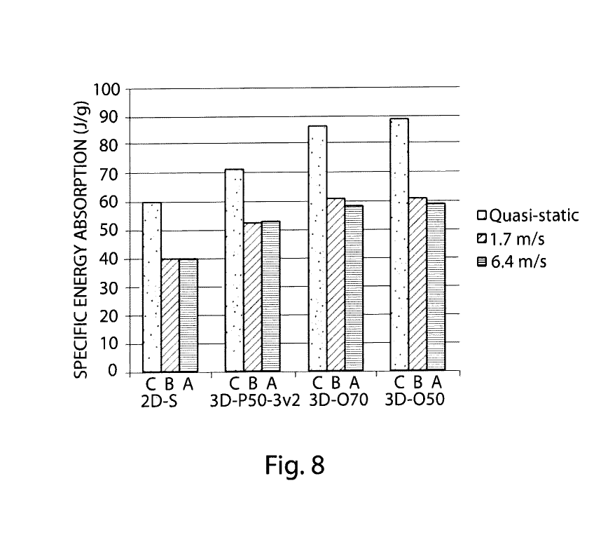

FIG. 8 illustrates a chart comparing rate dependent SEA values for four configurations. Medium (1.7 m/s) (A) and high-rate (6.4 m/s) (B) dynamic testing results showed the same trends with a roughly 33% drop in SEA for 2D-S and a 26% drop for 3D-O50 over quasi-static dynamic values (C).

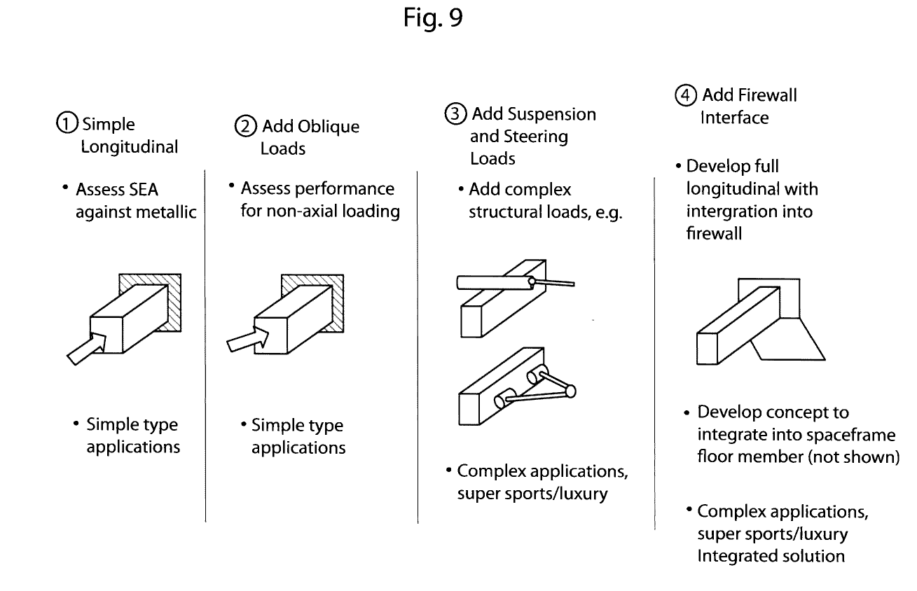

FIG. 9 illustrates four variants of a possible automotive application for the development of a 3D woven composite longitudinal component. In FIG. 9 an automotive crash tube application is shown that provides different levels of structural support and integration, for example, (1) parasitic and only for frontal impact, (2) parasitic and for frontal and side impact, (3) combined crash-structural with driving loads, (4) integrated with other surrounding structures in the vehicle to reduce part count and cost.

It should be appreciated that the threads in the warp and weft directions may be of different material and/or sizes. The material of the threads, yarns, or fibers is not limited. While carbon fiber is described, the threads, yarns or fibers of the invention is applicable to practically any other fiber type, such as for example, glass, ceramic, aramid, polyethylene, polypropylene, stretch broken fibers such as stretch broken carbon fibers (SBCF) or other materials that can be stretch broken, or combinations of materials thereof, or any suitable material.

It should be appreciated that, although FIGS. 1A-5 describes several weaving patterns as examples, the present invention is, however, not limited to the described weaving patterns. Other embodiments are within the scope of the following claims.

1. A three-dimensional (3D) composite article comprising:
a 3D woven preform, the preform comprising:
a plurality of warp yarns;
a plurality of weft yarns, the warp yarns woven with the weft yarns to form a structure having a plurality of layers of the 3D woven preform;
a matrix material,
wherein the 3D woven composite article has a specific energy absorption (SEA) greater than a 2D woven laminated preform of substantially the same weight, when each preform is impregnated with the matrix material to form the composite article.

2. The 3D composite article of claim 1, wherein the 3D woven composite article has the specific energy absorption (SEA) at least 10% greater than the 2D woven laminated preform of substantially the same weight.

3. The 3D composite article of claim 1, wherein the 3D woven composite article has the specific energy absorption (SEA) at least 20% greater than the 2D woven laminated preform of substantially the same weight.

4. The composite article of claim 1,
wherein one or more warp yarns selected from the plurality of warp yarns in a particular layer are first binder yarns that bind weft yarns in the particular layer to weft yarns in another layer, and
wherein one or more weft yarns selected from the plurality of weft yarns in the particular layer are second binder yarns that bind warp yarns in the particular layer to warp yarns in the another layer.

5. The composite article of claim 4, wherein the another layer is an adjacent next layer to the particular layer.

6. The composite article of claim 4, wherein the another layer is not an adjacent next layer to the particular layer.

7. The composite article of claim 4, wherein the matrix material is selected from the group consisting of epoxy, polyester, vinyl-ester, ceramic, and carbon.

8. The composite article of claim 1, wherein the article is formed into a vehicle crash structure.

9. A three-dimensional (3D) woven preform comprising:
a plurality of warp yarns;
a plurality of weft yarns, the warp yarns woven with the weft yarns to form a structure having a plurality of layers of the 3D woven preform,
wherein one or more warp yarns selected from the plurality of warp yarns in a particular layer are first binder yarns that bind weft yarns in the particular layer to weft yarns in a another layer, and
wherein one or more weft yarns selected from the plurality of weft yarns in the particular layer are second binder yarns that bind warp yarns in the particular layer to warp yarns in the another layer.

10. The three-dimensional (3D) woven preform of claim 9, wherein the preform is impregnated with matrix material.

11. The three-dimensional (3D) woven preform of claim 10, wherein the matrix material is selected from the group consisting of epoxy, polyester, vinyl-ester, ceramic, and carbon.

12. The three-dimensional (3D) woven preform of claim 10, wherein the another layer is an adjacent next layer to the particular layer.

13. The three-dimensional (3D) woven preform of claim 8, wherein the another layer is not an adjacent next layer to the particular layer.

14. A method of forming a composite article comprising:
forming a three-dimensional (3D) woven preform by weaving a plurality of warp yarns with a plurality of weft yarns to form a structure having a plurality of layers of the 3D woven preform;
impregnating the 3D woven preform with a matrix material,
wherein the 3D woven composite has a specific energy absorption (SEA) is greater than a 2D woven laminated preform of substantially the same weight, when each preform is impregnated with the matrix material to form the composite article.

15. The method of claim 14, wherein the 3D woven composite article has the specific energy absorption (SEA) at least 10% greater than the 2D woven laminated preform of substantially the same weight.

16. The method of claim 15, wherein the 3D woven composite comprising said preform has the specific energy absorption (SEA) at least 20% greater than the 2D woven laminated preform of substantially the same weight.

17. The method of claim 15, comprising:
binding weft yarns in a particular layer to weft yarns in another layer with first binder yarns, the first binder yarns being one or more warp yarns selected from the plurality of warp yarns in the particular layer, and
binding warp yarns in a particular layer to warp yarns in the another layer with second binder yarns, the second binder yarns being one or more weft yarns selected from the plurality of weft yarns in the particular layer.

18. The method of claim 17, wherein the another layer is an adjacent next layer to the particular layer.

19. The method of claim 17, wherein the another layer is not an adjacent next layer to the particular layer.

20. The method of claim 17, wherein the matrix material is selected from the group consisting of epoxy, polyester, vinyl-ester, ceramic, and carbon.

21. The method of claim 14, comprising forming the article into a vehicle crash structure.

22. A method of forming a three-dimensional (3D) woven preform comprising:
weaving a plurality of warp yarns with a plurality of weft yarns to form a structure having a plurality of layers of the 3D woven preform;
wherein one or more warp yarns selected from the plurality of warp yarns in a particular layer are first binder yarns that bind weft yarns in the particular layer to weft yarns in a another layer, and
wherein one or more weft yarns selected from the plurality of weft yarns in the particular layer are second binder yarns that bind warp yarns in the particular layer to warp yarns in the another layer.

23. The method of claim 22, wherein the preform is impregnated with matrix material.

24. The method of claim 23, wherein the matrix material is selected from the group consisting of epoxy, polyester, vinyl-ester, ceramic, and carbon.

25. The method of claim 22, wherein the another layer is an adjacent next layer to the particular layer.

26. The method of claim 22, wherein the another layer is not an adjacent next layer to the particular layer.
